(19) United States
(12) Patent Application Publication
(10) Pub. No.: US 2018/0220134 A1
(43) Pub. Date: Aug. 2, 2018

(54) VIDEO COMPRESSION FOR NON-UNIFORM RESOLUTION REQUIREMENTS

(71) Applicant: PERASO TECHNOLOGIES INC., Toronto (CA)

(72) Inventors: Bradley Robert LYNCH, Toronto (CA); Gary CHENG, Unionville (CA)

(21) Appl. No.: 15/887,339

(22) Filed: Feb. 2, 2018

Related U.S. Application Data
(60) Provisional application No. 62/453,614, filed on Feb. 2, 2017.
(60) Provisional application No. 62/529,839, filed on Jul. 7, 2017.

(51) Int. Cl. H04N 19/172; H04N 19/70; H04W 72/08

(52) U.S. Cl. CPC H04N 19/172; H04W 72/085; H04N 19/70

(57) ABSTRACT

A method of generating video data for delivery over a network link to a display includes: obtaining a positional indicator corresponding to the display; generating, based on the positional indicator, distinct primary and secondary region definitions; selecting primary and secondary compression levels for the region definitions, the secondary compression level being greater than the primary compression level; generating a compressed video frame from an initial video frame by: applying, to a portion of the initial video frame identified by the primary region definition, a first compression operation according to the primary compression level; applying, to another portion of the initial video frame identified by the secondary region definition, a second compression operation according to the secondary compression level; and transmitting, for delivery to the display, the compressed video frame and a frame descriptor indicating the primary and secondary region definitions, and configuration parameters for the first and second compression operations.

### CROSS-REFERENCE TO RELATED APPLICATIONS

This application claims priority to U.S. provisional patent application Nos. 62/453,614 filed Feb. 2, 2017, and 62/529,839 filed Jul. 7, 2017. The contents of the above-mentioned applications are incorporated herein by reference.

### FIELD

The specification relates generally to video delivery, and specifically to a method, system and apparatus of generating video data for delivery over a network link to a display device.

### BACKGROUND

Media streaming systems, such as virtual reality systems in which a user wears a headset or other device displaying video, may rely on a distinct host device such as a game console to generate the video and stream the video to the headset. The communication link between the host device and the headset or other client device is increasingly being deployed as a wireless link, which is susceptible to degradation due to physical interference and the like. In the present of degradation, the link may not provide sufficient bandwidth to reliably carry the video stream. Reduced bandwidth availability may be accommodated by compressing the video stream, but such compression typically results in a loss of visual fidelity, reducing the quality of the video as perceived by the viewer at the client device.

### SUMMARY

An aspect of the specification provides a method of generating video data for delivery over a network link to a display, the method comprising: obtaining a positional indicator corresponding to the display; generating, based on the positional indicator, (i) a primary region definition and (ii) a secondary region definition distinct from the primary region definition; selecting (i) a primary compression level corresponding to the primary region definition, and (ii) a secondary compression level corresponding to the secondary region definition, the secondary compression level being greater than the primary compression level; generating a compressed video frame from an initial video frame by: applying, to a first portion of the initial video frame identified by the primary region definition, a first compression operation according to the primary compression level; applying, to a second portion of the initial video frame identified by the secondary region definition, a second compression operation according to the secondary compression level; and transmitting, for delivery to the display, the compressed video frame and a frame descriptor indicating (i) the primary and secondary region definitions, and (ii) configuration parameters for the first and second compression operations.

A further aspect of the specification provides a host device for generating video data for delivery over a network link to a display, the host device comprising: a memory; a communications interface; and a processor interconnected with the memory and the communications interface, the processor configured to: obtain a positional indicator corresponding to the display; generate, based on the positional indicator, (i) a primary region definition and (ii) a secondary region definition distinct from the primary region definition; select (i) a primary compression level corresponding to the primary region definition, and (ii) a secondary compression level corresponding to the secondary region definition, the secondary compression level being greater than the primary compression level; generate a compressed video frame from an initial video frame by: applying, to a first portion of the initial video frame identified by the primary region definition, a first compression operation according to the primary compression level; applying, to a second portion of the initial video frame identified by the secondary region definition, a second compression operation according to the secondary compression level; and transmit, for delivery to the display, the compressed video frame and a frame descriptor indicating (i) the primary and secondary region definitions, and (ii) configuration parameters for the first and second compression operations.

### BRIEF DESCRIPTIONS OF THE DRAWINGS

Embodiments are described with reference to the following figures, in which:

FIG. 1 is a block diagram of a wireless multimedia communication system;

FIG. 2A is a block diagram of certain components of a host device of FIG. 1;

FIG. 2B is a block diagram of certain components of a client device of FIG. 1;

FIG. 3 is a flowchart of a method for generating video data;

FIG. 4 is a flowchart of a method for generation region definitions and selecting corresponding compression levels;

FIGS. 5A-5C depict the generation of region definitions; and

FIGS. 6A-6B depict the generation of auxiliary region definitions.

### DETAILED DESCRIPTION

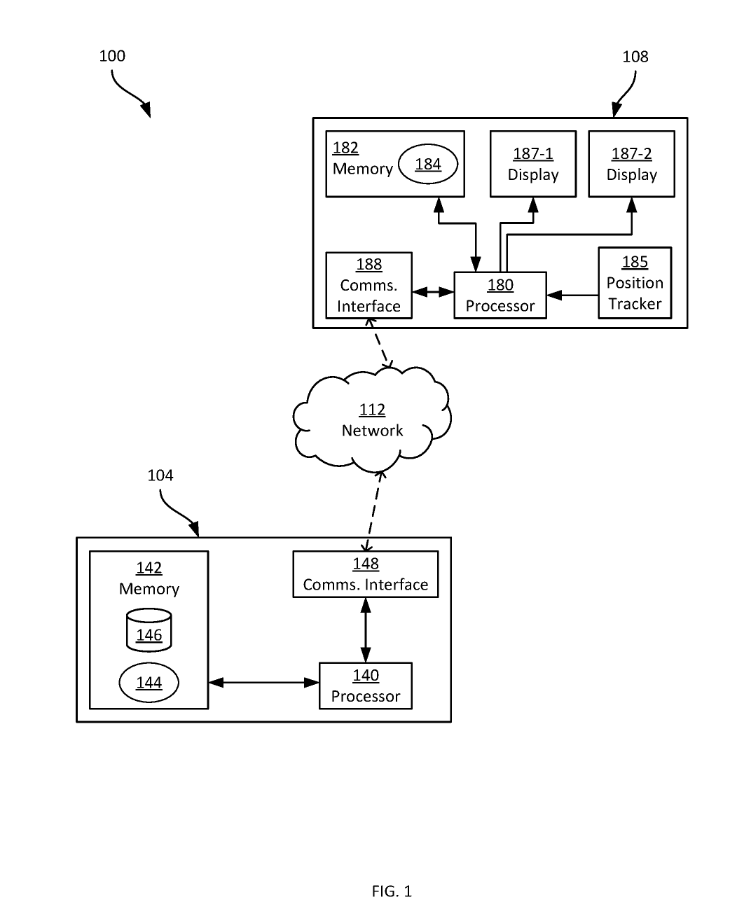

FIG. 1 depicts a wireless multimedia communication system 100 including a host computing device 104 and a client computing device 108. In general, the host device 104 (e.g. a personal computer, game console, or the like) is configured to generate and transmit multimedia, including video data (e.g. a stream of video frames) to the client device 108 via a network 112. The client device 108 is configured to receive and process the above-mentioned video data following receipt of the data via the network 112, and to present the video data on one or more displays of the client device 108, to be discussed below. More specifically, as discussed below in greater detail below, the host device 104 is configured to dynamically apply distinct levels of compression to different portions of each video frame based on information received from the client device 108.

To that end, the host device 104 includes a central processing unit (CPU), also referred to as a processor 140. The processor 140 is interconnected with a non-transitory computer readable storage medium, such as a memory 142, having stored thereon various computer readable instructions in the form of an application 144 for execution by the processor 140 to configure the host device 104 to perform various functions (e.g. generating and streaming video data to the client device 108). The memory 142 also stores a repository 146 of multimedia data for use in generating the above-mentioned video data. The memory 142 includes a suitable combination of volatile (e.g. Random Access Memory or RAM) and non-volatile memory (e.g. read only memory or ROM, Electrically Erasable Programmable Read Only Memory or EEPROM, flash memory). The processor 140 and the memory 142 each comprise one or more integrated circuits.

The host device 104 may also include one or more input devices (e.g. a keyboard, mouse, game controller or the like, not shown), and one or more output devices (e.g. a display, speaker and the like, not shown). Such input and output devices serve to receive commands for controlling the operation of the host device 104 and for presenting information, e.g. to a user of the host device 104. The host device 104 further includes a wireless communications interface 148 interconnected with the processor 140. The interface 148 enables the host device 104 to communicate with other computing devices, including the client device 108. The nature of the interface 148 is selected according to the type of the network 112. In the present example, the network is a wireless local-area network (WLAN), such as a network based on the IEEE 802.11ad standard or the 802.11ay enhancement thereto (which specify operation at frequencies of about 60 GHz). The interface 148 therefore includes any suitable combination of antenna elements, transceiver components, controllers and the like, to enable communication over such a network.

The client device 108, in the present example, is implemented as a head-mounted unit supported by a headband or other mount that is wearable by an operator (not shown). The client device 108 includes a central processing unit (CPU), also referred to as a processor 180. The processor 180 is interconnected with a non-transitory computer readable storage medium, such as a memory 182, having stored thereon various computer readable instructions in the form of an application 184 for execution by the processor 180 to configure the client device 108 to perform various functions (e.g. receiving video data from the host device 104 and presenting the video data to a viewer or viewers of the client device 108). The memory 182 includes a suitable combination of volatile (e.g. Random Access Memory or RAM) and non-volatile memory (e.g. read only memory or ROM, Electrically Erasable Programmable Read Only Memory or EEPROM, flash memory). The processor 180 and the memory 182 each comprise one or more integrated circuits.

The client device 108 also include one or more input devices. The input devices of the client device 108 include a position tracker 185, which in the present example is an eye-tracking device. The position tracker 185 is configured to generate, and provide to the processor 180, indications of a position of the center of the visual field of a viewer of the client device 108. That is, the position tracker 185 is configured to track the gaze of the viewer by any suitable eye-tracking technology (e.g. retinal tracking).

The client device 108 also includes one or more output devices. In the present example, the output devices include at least one display 187. Specifically, as shown in FIG. 1, the client device 108 includes a pair of displays 187-1 and 187-2, arranged for viewing by respective eyes of the viewer. In other examples, a single display 187 may be provided in the client device 108. The above-mentioned positional data provided to the processor 180 by the position tracker 185 indicates the position, and optionally the velocity (i.e. the direction of travel and speed of travel), of the viewer's gaze, in a frame of reference corresponding to the display 187. For example, the positional data can be provided in pixel coordinates based on the horizontal and vertical pixel axes of the display 187. As will now be apparent, the position tracker 185 can be configured to generate positional indicators for each display 187 (i.e. for each eye of the viewer). In other examples, the position tracker 185 tracks only one eye, and the resulting positional indicator is used in subsequent computations as a representation of the position of both eyes.

The client device 108 can also include further input devices (e.g. a microphone, a keypad, keyboard, or the like) and further output devices (e.g. one or more speakers). In addition, the client device 108 includes a wireless communications interface 188 interconnected with the processor 180. The interface 188 enables the client device 108 to communicate with other computing devices, including the host device 104. In the present example, as noted above in connection with the host device 104, the network 112 is based on the IEEE 802.11ad standard or the 802.11ay enhancement thereto. The interface 188 therefore includes any suitable combination of antenna elements, transceiver components, controllers and the like, to enable communication over the network 112 at frequencies of around 60 GHz.

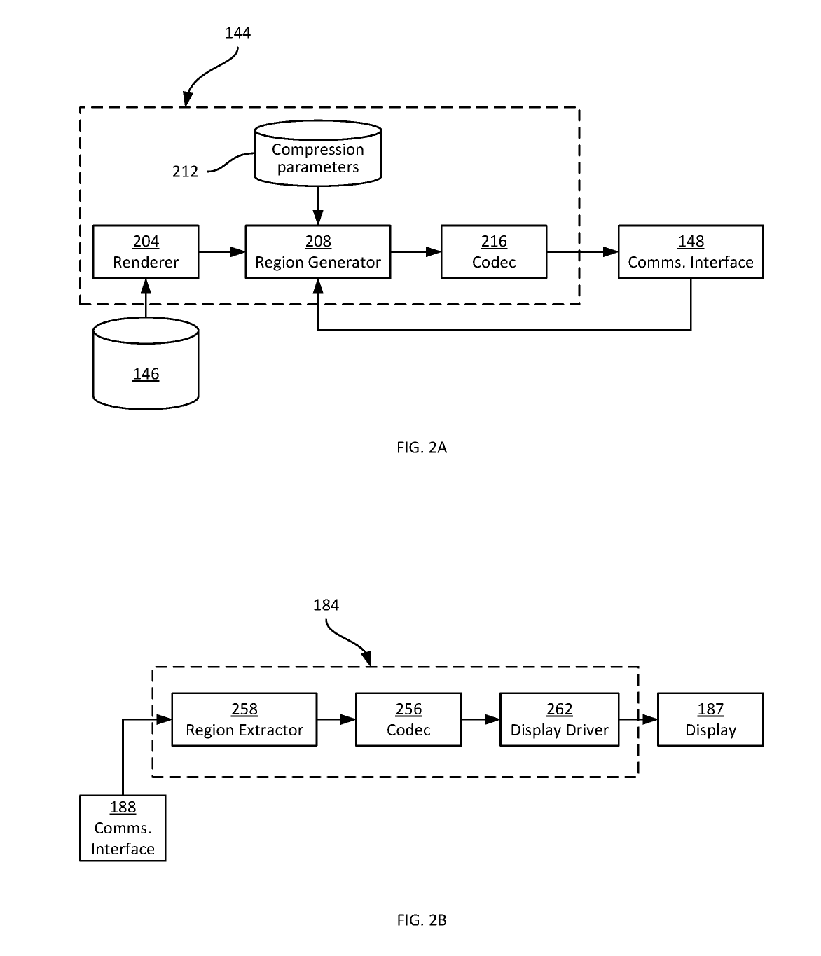

Turning to FIGS. 2A and 2B, certain components of the applications 144 and 184, respectively, are illustrated. In other embodiments, the components of either or both of the applications 144 and 184 may be implemented as a plurality of distinct applications executed by the processors 140 and 180, respectively. In further examples, one or more of the components of the applications 144 and 184 can be implemented as dedicated hardware elements (e.g. one or more field-programmable gate arrays (FPGAs), application-specific integrated circuits (ASICs) or the like) rather than as computer-readable instructions.

Referring to FIG. 2A, the application 144 includes a renderer 204, configured to retrieve multimedia data from the repository 146 and generate frames of video data. The multimedia data can include any combination of images, depth data, geometry data (e.g. defining vertices, polygons, and the like). The application 144 also includes a region generator 208, configured to receive the frames of video data from the rendered 204 and to generate, as will be discussed in greater detail below, a plurality of region definitions corresponding to distinct regions of each frame to which different levels of compression will be applied. The region generator 208 is configured to pass the video frames, along with the region definitions and compression parameters for each region retrieved from a predefined set of compression parameters 212, to a codec 216. The codec 216 is configured to apply compression operations on the video frames according to the region definitions and compression parameters received from the region generator 208. Following application of the compression parameters, the codec 216 is configured to pass the compressed video frames to the communications interface 148 for further processing and transmission to the client device 108. As shown in FIG. 2A, the region generator 208 is also configured to receive, via the communications interface, positional indicators from the client device 108, for use in generating the above-mentioned region definitions.

Turning to FIG. 2B, the application 184 includes a region extractor 258 configured to extract, from data received from the host device 104 via the communications interface 188, the region definitions and compression parameters mentioned earlier, for provision to a codec 256. The codec 256, in turn, is configured to decompress the video frames according on the region definitions and compression parameters. The decompressed video frames are passed to a display driver 262, which controls the display(s) 187 to present the video frames. The application 184 may also include a component (not shown) configured to receive positional indicators from the position tracker 185 and report the positional indicators to the host device 104 via the communications interface 188.

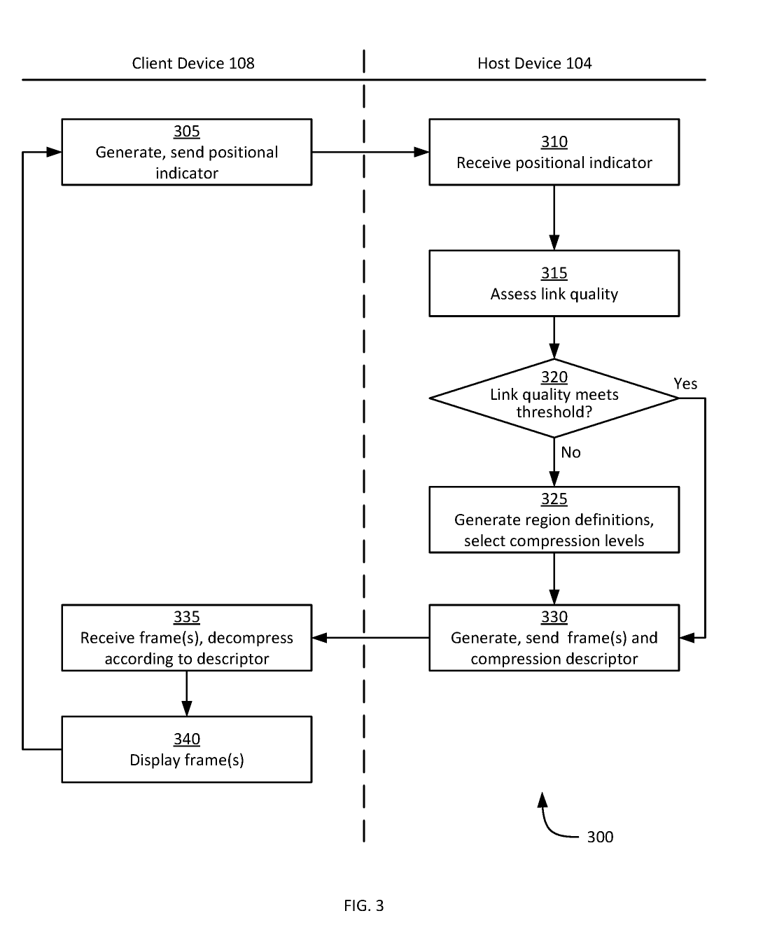

Turning now to FIG. 3, the operation of the devices 104 and 108 will be described in greater detail. FIG. 3 illustrates a method 300 of generating video data for delivery over a network link to a display device. The method 300 will be described in conjunction with its performance on the system 100. As indicated in FIG. 3, certain blocks of the method 300 are performed by the client device 108, while other blocks are performed by the host device 104. In the discussion below, the client device 108 and the host device 104 are said to perform various actions. It will be understood that such performance is implemented via the execution of the applications 184 and 144 by the processors 180 and 140, respectively.

At block 305, the client device 108 is configured to generate a positional indicator corresponding to at least one of the displays 187. As discussed below, the positional indicator reflects the direction of the viewer's gaze. Therefore, at block 305 two positional indicators may be generated, each corresponding to one eye and one of the displays 187. In the discussion below, a single positional indicator will be discussed, with the understanding that when two positional indicators are to be employed, the process below is repeated for each eye and corresponding display 187.

The positional indicator indicates a position, on the display 187, of a field of view of the viewer of the display 187. More specifically, in the present example, the positional indicator indicates a position of a center, or central region, of the field of view. The positional indicator is expressed in a frame of reference corresponding to the display 187 (e.g. as pixel coordinates). As will be apparent to those skilled in the art, the positional indicator is generated via data received from the position tracker 185, which may be a retinal tracker or the like. The positional indicator defines at least a position of the field of view, and can also define a velocity of the field of view, indicating in which direction and at what speed the viewer's eye is moving. For example, the position tracker 185 can be configured to assess the position of the eye at a predefined frequency, and to determine the velocity based on any suitable number of position samples. Preferably the sampling frequency of the position tracker 185 is greater than the frame rate of the video data. For example, in some embodiments the video data may include a series of video frames displayed at a rate of about 90 frames per second, and the position tracker 185 may generate about 120 samples per second. Greater sampling rates (e.g. 300 Hz) may also be employed, as well as smaller sampling rates (e.g. 60 Hz).

Having obtained the positional indicator, the client device 108 is configured to transmit the positional indicator to the host device 104 via the network 112. At block 310, the host device 104 is configured to receive the positional indicator. At block 315, the host device 104 can be configured to assess a quality of the link between the host device 104 and the client device 108 via the network 112. For example, the host device 104 can be configured to track one of more of a signal-to-noise ratio (SNR), an indication of available bandwidth, a received signal strength indicator (RSSI) and the like. In general, the assessment of link quality at block 315 permits the host device 104 to determine whether the link via the network 112, over which video data is to be transmitted, provides sufficient bandwidth to carry to video stream.

Thus, at block 320, the host device 104 is configured to determine whether the link quality meets a predefined threshold. The threshold is defined based on the parameter(s) measured at block 315 for link quality assessment. For example, if SNR is measured at block 315, the determination at block 320 can include comparison of a measured SNR to a minimum threshold SNR.

When the determination at block is negative (i.e. when the assessed link quality does not meet the predefined threshold mentioned above), performance of the method 300 proceeds to block 325. At block 325 the host device 104 is configured to select and apply two or more distinct compression operations to regions of a video frame before transmitting the frame. In some embodiments, blocks 315 and 320 are omitted, and the performance of the method 300 instead always proceeds to block 325. When the determination at block 320 is affirmative, the above-mentioned compression may be omitted, and performance of the method 300 proceeds directly to block 330.

At block 325, the host device 104 is configured to generate at least a primary region definition and a secondary region definition distinct from the primary region definition. The host device 104 is also configured to select respective compression levels for the regions generated at block 325. As will be seen in greater detail below, the compression levels and the region definitions are employed by the host device 104 to generate video frames in which different portions are compressed to different degrees.

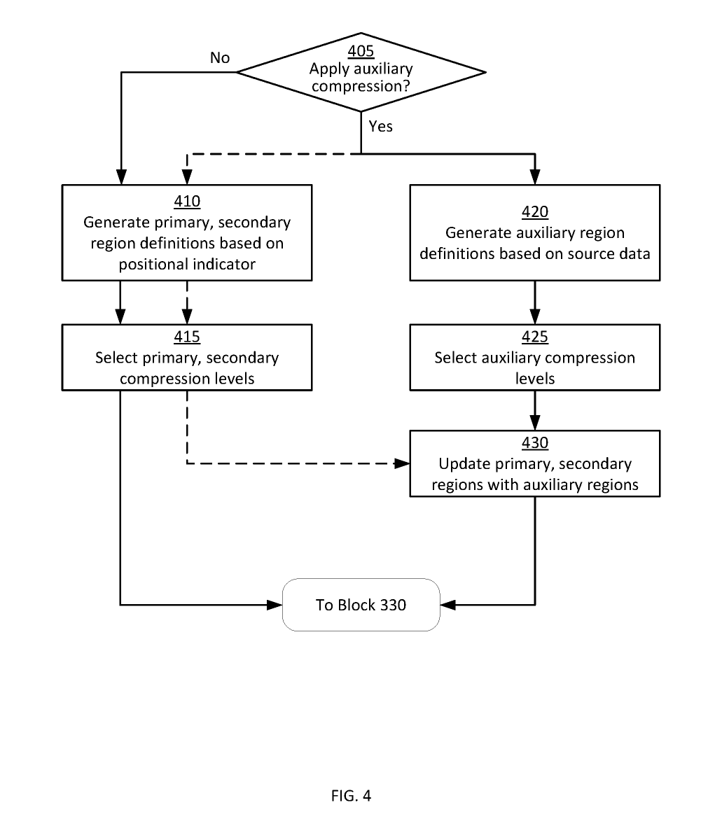

Turning to FIG. 4, a method 400 of generating region definitions and selecting compression levels (i.e. a method of performing block 325) is shown. At block 405, the host device 104 is configured to determine whether to apply auxiliary compression. As discussed below, the host device 104 is configured to generate the region definitions and select compression levels at least based on the positional indicator received at block 310. In some examples, or under certain conditions, the region definitions can also be based on the multimedia data in repository 146 itself. The determination at block 405 is thus a determination of whether to generate the region definitions based solely on the positional indicator, or based on both the positional indicator and the multimedia data (also referred to as “source” data).

The determination at block 405 can be based on the link quality assessment at block 315. For example, the host device 104 can be configured to compare the assessed link quality both to the above-mentioned threshold applied at block 320, as well as to a secondary threshold lower than the threshold applied at block 320. If the link quality fails to meet the initial threshold of block 320 but does meet the threshold of block 405, the determination at block 405 is negative. If, on the other hand, the assessed link quality fails to meet both thresholds, the determination at block 405 is affirmative. In other words, if the link quality is sufficiently low, additional compression may be required to accommodate the limited bandwidth available over the network 112.

Following either a positive or a negative determination at block 405, the host device 104 is configured to perform blocks 410 and 415. At block 410, the host device 104 (e.g. the region generator 208) is configured to generate at least a primary region definition and a secondary region definition based on the positional indicator received at block 310. The primary and secondary region definitions correspond to distinct regions of the display 187. In general, the region definitions are generated to correspond to regions of the display 187 to which different levels of compression may be applied with minimal effects on perceived image quality at the client device 108.

The ability of the human eye to distinguish detail decreases from the center of the visual field toward the outside of the visual field. For example, maximum resolution is typically available only over an arc of less than about 10 degrees. Therefore, images displayed at or near the center of the viewer's field of vision may be more susceptible to perceived degradation in quality when compressed, while images displayed away from the center of the viewer's field of vision may tolerate greater levels of compression before reduced image quality is perceived by the viewer. The host device 104 is configured to generate the primary and secondary region definitions according to the above radial decrease in

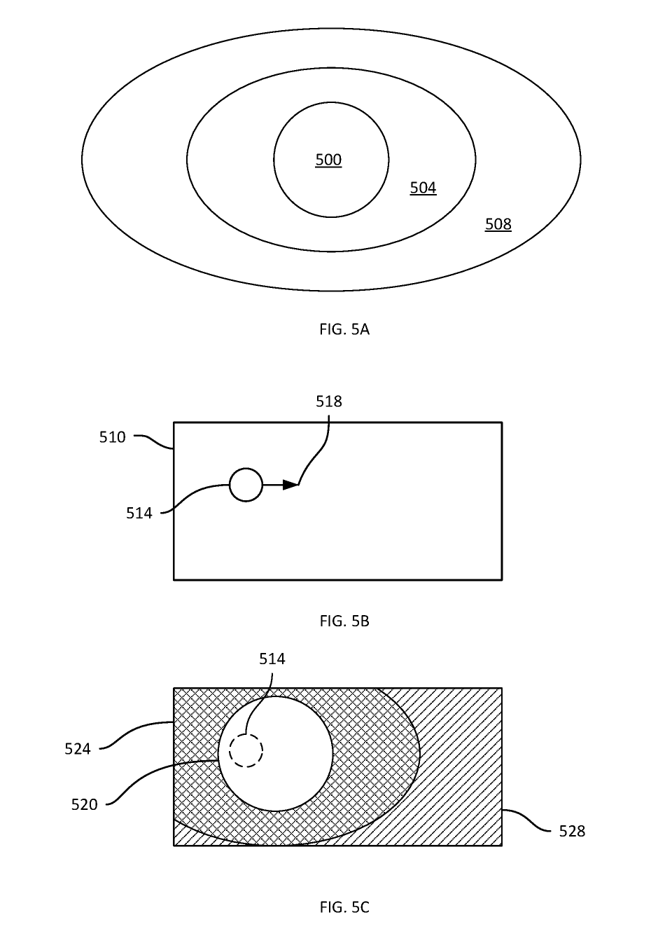

The host device 104, at block 410, is configured to retrieve one or more parameters from the memory 142 for use in generating the primary and secondary regions. For example, the parameters can define arcs corresponding to regions of the human field of vision with different perceived resolution. The arcs may be specified as angles in some embodiments. In other embodiments, in which the dimensions of the display 187 and the distance between the viewer's eye and the display 187 is known in advance, the parameters can be defined as two-dimensional areas and expressed in dimensions corresponding to those of the display 187. For example, referring to FIG. 5A, three areas 500, 504 and 508 are illustrated, corresponding respectively to a central portion of the human field of vision, and intermediate portion, and an outer portion. As will now be apparent, perceived resolution is greatest in the central area 500 and smallest in the outer area 508. Each of the portions may be defined, for example, in the memory 142, as a set of pixel coordinates, an equation defining an ellipse, or the like. A greater or smaller number of portions than the illustrated three may be employed in other embodiments.

To generate the region definitions at block 410, the host device 104 is configured to retrieve the portions shown in FIG. 5A, and to select a location for placement of the portions in the frame of reference defined by the display 187. The location is selected based on the positional indicator received at block 310. For example, if the positional indicator includes only eye position (and not velocity) the location may simply be selected as the position indicated by the positional indicator. In the present example, however, in which the positional indicator includes velocity, the host device 104 is configured to adjust the selected location according to the velocity. For example, referring to FIG. 5B, the frame of reference 510 defined by the display 187 is shown (e.g. an area of 1920 pixels horizontally by 1080 pixels vertically). In addition, the positional indicator is illustrated, including a position 514 of the center of the viewer's visual field and a velocity vector 518 indicating the direction and speed of travel of the viewer's eye over the display 187.

FIG. 5C illustrates an example of a primary region definition 520, a secondary region definition 524, and a tertiary region definition 528, generated based on the indicators 514 and 518 and the parameters shown in FIG. 5A. In particular, the sections of the visual field shown in FIG. 5A are overlaid on the area of the display 187, centered at a location selected based on the indicators 514 and 518. In particular, the regions 520, 524 and 528 are not centered directly over the indicator 514, but are instead shifted in the direction of the velocity indicator 518 (e.g. by a distance proportional to the magnitude of the velocity indicator 518). As seen in FIG. 5C, the three region definitions correspond to distinct portions of the display 187, and together represent the entire area of the display 187.

Returning to FIG. 4, having generated the region definitions, the host device 104 is configured to select a compression level for each region definition. Thus, the host device 104 is configured to select at least a primary compression level and a secondary compression level. In the present example, in which three region definitions are generated, the host device 104 is configured to select three corresponding compression levels at block 415. The compression levels are selected from a preconfigured set of levels, which may for example be stored along with the compression parameters 212 mentioned in connection with FIG. 2. In general, the compression level selected for the primary region is less aggressive (i.e. represents a lower compression ratio) than the compression level selected for the secondary region, which in turn represents a lower compression ratio than the level selected for the tertiary region. Examples of compression levels and corresponding compression parameters are shown below in Table 1.

TABLE 1
Compression Parameters 212

| Compression Level | Compression Parameters |
|---|---|
| 1 | N/A |
| 2 | Display Stream Compression 1.2 |
| 3 | H.264, bitrate A |
| 4 | H.264, bitrate B |

As seen above, each compression level corresponds to a set of compression parameters specifying a compression algorithm and any suitable settings for the specified algorithm. For example, the compression level “1” specifies no compression. The compression level “2”, meanwhile, specifies the use of the display stream compression (DSC) algorithm, which is generally considered a visually lossless algorithm, with a compression ratio of about 3 to 1. In other words, the second compression level specifies a greater level of compression than the first. The third and fourth levels of compression specify still greater levels. For example, the third and fourth levels may both specify use of the H.264 (also referred to as MPEG-4 AVC), with different data rates (the data rate “A” being greater than the data rate “B”). As will be apparent to those skilled in the art, H.264 may achieve compression ratios significantly greater than 3 to 1, at the cost of some loss of visual fidelity with the original video data.

Table 1 contains four compression levels. In other embodiments, greater numbers of compression levels may be defined in the compression parameters 212. In further embodiments, as few as two levels may be defined. The host device 104 can be configured, when a greater number of levels are available than there are region definitions, to select which compression levels to employ based on the link assessment at block 315.

Following the performance of block 415, the host device proceeds to block 330, shown in FIG. 3. Before discussion of block 330, however, the implementation of auxiliary compression following an affirmative determination at block 405 will be discussed.

When, at block 405, the host device 104 determines that auxiliary compression is also to be applied to one or more video frames, blocks 410 and 415 are performed as described above. In addition, the host device 104 is configured to perform block 420 (e.g. in parallel with block 410). At block 420, the host device 104 (e.g. the region generator 208) is configured to generate one or more auxiliary region definitions based on the source data stored in the repository 146, from which the video frames are generated (e.g. by the renderer 204). The auxiliary region definitions identify additional portions of the video frame, beyond the above-mentioned primary, secondary and tertiary (where employed) region definitions generated at block 410, for compression. In general, the generation of auxiliary region definitions at block 420 by the host device 104 includes inspection of the source data in the repository 146 for portions of the source data that give certain predefined characteristics to corresponding regions of the resulting video frame.

Examples of such predefined characteristics include regions of a video frame representing content at or beyond a certain depth from the viewer, which may be more tolerant of greater level of compression than content below the above-mentioned depth. Further examples of such predefined characteristics include regions of a video frame with polygon density below a configurable threshold (which may tolerate greater compression), as well as regions of a video frame with polygon density above a further configurable threshold (which may be less tolerant of compression). Still further examples include regions of a video frame with a density of edges or other features that is greater than a threshold (which may be less tolerant of compression), as well as regions with a density of edges or other features below a threshold (which may be more tolerant of compression).

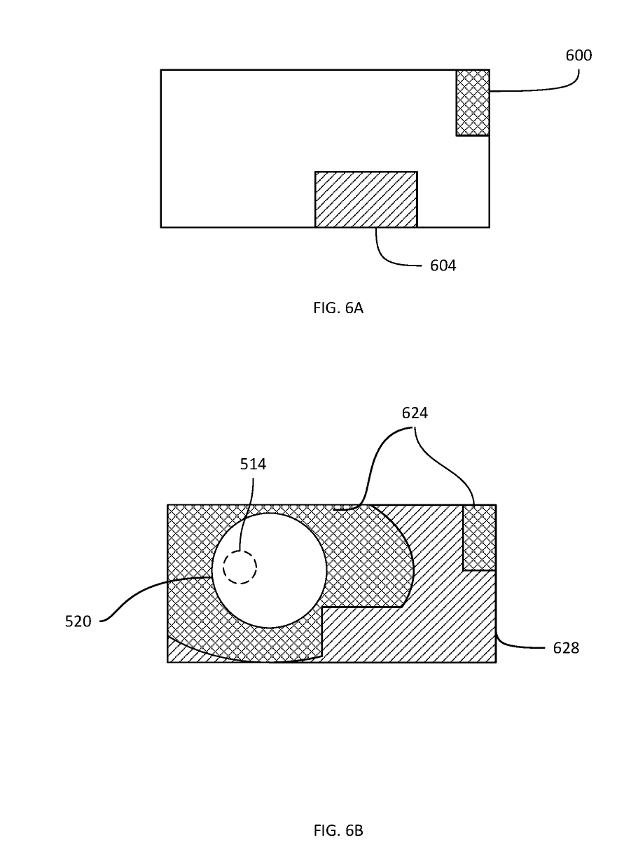

At block 425, the host device 104 is configured to select auxiliary compression levels for the auxiliary region definitions generated at block 420. The auxiliary compression levels are selected from the compression parameters 212, as discussed above. For example, turning to FIG. 6A, two auxiliary regions 600 and 604 are illustrated, along with respective selected compression levels.

Returning briefly to FIG. 4, at block 430 the host device 104 is configured to update the primary and secondary region definitions (and any further region definitions generated) from block 410 with the auxiliary region definitions. Turning to FIG. 6B, a set of update primary, secondary and tertiary region definitions are shown. In particular, the primary region definition 520 is unchanged from FIG. 5B, while the region definition 524 has been updated to the secondary region definition 624, which includes both a portion of the region definition 524 (subtracted by a portion of the auxiliary region definition 604) and the region definition 600. The tertiary region definition 528 has been updated to a tertiary region definition 628, which omits the portion of the frame defined by the region 600, and includes the portion of the frame defined by the region 604.

As will now be apparent, the updating performed at block 430 includes collecting all sub-regions with the same compression level into a single one of the primary, secondary and tertiary regions. Thus, the auxiliary region definition 600 is included in the updated secondary region definition 624 because the auxiliary region definition 600 has the same compression level as the secondary region definition 524. In other embodiments, the updating operation can include further determinations. For example, since each auxiliary region definition overlays at least one of the region definitions generated at block 410, the updated region definitions may be generated by averaging the compression level of an auxiliary region definition (selected at block 425) with the compression level(s) of the underlying region definition(s) generated at block 410. In further examples, the compression levels selected at block 425 may be applied to portions of the underlying region definitions from block 410 as increments or decrements, based on whether the auxiliary compression levels are higher or lower than the compression levels selected at block 415. In further examples, the region generator 208 is configured to apply minimum and/or maximum compression limits to the updated compression levels. For example, the region generator 208 can prevent any portion of the primary region definition 520 from being assigned a compression level greater than the level “1” from the table above, irrespective of compression levels selected for auxiliary region definitions that overlay the primary region definition 520.

In other embodiments, the determination at block 405 may be omitted, and both branches of region generation shown in FIG. 4 may always be performed. In still other examples, blocks 405, as well as blocks 420, 425 and 430 may all be omitted.

Following the completion of block 415 or block 430, the host device 104 is configured, at block 330, to generate and send one or more video frames compressed according to the region definitions and levels discussed above. Specifically, initial video frame(s) are rendered from the source data by the renderer 204, compressed by the codec 216 according to the region definitions and compression levels selected by the region generator 208, and provided to the communications interface 148 for transmission. The resulting frame or set of frames include both the video frames themselves, compressed as noted above, and a compression descriptor that includes the region definitions and compression levels according to which the frames were compressed. The compression descriptor includes coordinates or other definitions of the region definitions, as well as the compression levels assigned to each region definition. The compression descriptor can also include the compression settings corresponding to each compression level, though in other embodiments, the client device 108 may also store a copy of the compression parameters 212 in the memory 142. The compression descriptor is contained in one or more metadata fields associated with a frame or group of frames.

The client device 108 is configured, at block 335, to receive the frame(s) from the host device 104 and to decompress the frames according to the descriptor mentioned above. In particular, in the present example the frames are received via the communications interface 188, following which the region extractor 258 is configured to identify and extract the compression descriptor from the frames and transmit the compressed frames and the region definitions and compression levels to the codec 256. The codec 256 is configured to decompress the frames according to the region definitions and the compression levels, and pass the decompressed frames to the display driver 262 for presentation on the display 187. As will now be apparent, the method 300 may be repeated for a subsequent frame or group of frames.

The scope of the claims should not be limited by the embodiments set forth in the above examples, but should be given the broadest interpretation consistent with the description as a whole.

1. A method of generating video data for delivery over a network link to a display, the method comprising:
obtaining a positional indicator corresponding to the display;
generating, based on the positional indicator, (i) a primary region definition and (ii) a secondary region definition distinct from the primary region definition;
selecting (i) a primary compression level corresponding to the primary region definition, and (ii) a secondary compression level corresponding to the secondary region definition, the secondary compression level being greater than the primary compression level;
generating a compressed video frame from an initial video frame by:
applying, to a first portion of the initial video frame identified by the primary region definition, a first compression operation according to the primary compression level;
applying, to a second portion of the initial video frame identified by the secondary region definition, a second compression operation according to the secondary compression level; and
transmitting, for delivery to the display, the compressed video frame and a frame descriptor indicating (i) the primary and secondary region definitions, and (ii) configuration parameters for the first and second compression operations.

2. The method of claim 1, wherein obtaining the positional indicator includes receiving the positional indicator from a client device coupled to the display.

3. The method of claim 2, wherein the positional indicator includes a position and a velocity.

4. The method of claim 3, wherein the position is a center of a field of view, and wherein the velocity is a velocity of movement of the field of view.

5. The method of claim 1, wherein generating the primary and secondary region definitions includes:
retrieving region definition parameters from a memory;
selecting respective locations for the primary and secondary regions based on the positional indicator.

6. The method of claim 1, further comprising:
prior to generating the primary and secondary regions, determining whether a quality of the network link meets a predefined threshold.

7. The method of claim 6, wherein determining whether the quality of the network meets the threshold includes at least one of: determining an available bandwidth, determining a signal-to-noise ratio, and determining a received signal strength indicator (RSSI) associated with the network link.

8. The method of claim 1, wherein the compression descriptor is included in at least one metadata field of the compressed video frame.

9. The method of claim 1, further comprising:
generating an auxiliary region definition;
selecting an auxiliary compression level for the auxiliary region definition; and
updating at least one of the primary and secondary region definitions based on the auxiliary region definition.

10. The method of claim 9, wherein generating the auxiliary region definition comprises inspecting source data used in generating the initial video frame.

11. A host device for generating video data for delivery over a network link to a display, the host device comprising:
a memory;
a communications interface; and
a processor interconnected with the memory and the communications interface, the processor configured to:
obtain a positional indicator corresponding to the display;
generate, based on the positional indicator, (i) a primary region definition and (ii) a secondary region definition distinct from the primary region definition;
select (i) a primary compression level corresponding to the primary region definition, and (ii) a secondary compression level corresponding to the secondary region definition, the secondary compression level being greater than the primary compression level;
generate a compressed video frame from an initial video frame by:
applying, to a first portion of the initial video frame identified by the primary region definition, a first compression operation according to the primary compression level;
applying, to a second portion of the initial video frame identified by the secondary region definition, a second compression operation according to the secondary compression level; and
transmit, for delivery to the display, the compressed video frame and a frame descriptor indicating (i) the primary and secondary region definitions, and (ii) configuration parameters for the first and second compression operations.

12. The host device of claim 11, wherein obtaining the positional indicator includes receiving the positional indicator from a client device coupled to the display.

13. The host device of claim 12, wherein the positional indicator includes a position and a velocity.

14. The host device of claim 13, wherein the position is a center of a field of view, and wherein the velocity is a velocity of movement of the field of view.

15. The host device of claim 11, wherein generating the primary and secondary region definitions includes:
retrieving region definition parameters from a memory;
selecting respective locations for the primary and secondary regions based on the positional indicator.

16. The host device of claim 11, the processor further configured to:
prior to generating the primary and secondary regions, determine whether a quality of the network link meets a predefined threshold.

17. The host device of claim 16, wherein determining whether the quality of the network meets the threshold includes at least one of: determining an available bandwidth, determining a signal-to-noise ratio, and determining a received signal strength indicator (RSSI) associated with the network link.

18. The host device of claim 11, wherein the compression descriptor is included in at least one metadata field of the compressed video frame.

19. The host device of claim 11, the processor further configured to:
generate an auxiliary region definition;
select an auxiliary compression level for the auxiliary region definition; and
update at least one of the primary and secondary region definitions based on the auxiliary region definition.

20. The host device of claim 19, wherein generating the auxiliary region definition comprises inspecting source data used in generating the initial video frame.
